(19) United States
(12) Patent Application Publication
(10) Pub. No.: US 2016/0308669 A1
(43) Pub. Date: Oct. 20, 2016

(54) Method and System for Real Time Data Protection with Private Key and Algorithm for Transmission and Storage

(71) Applicants: Jian Ho, Santa Clara, CA (US); Jin Hong, Saratoga, CA (US)

(72) Inventors: Jian Ho, Santa Clara, CA (US); Jin Hong, Saratoga, CA (US)

(21) Appl. No.: 14/690,471

(22) Filed: Apr. 20, 2015

(51) Int. Cl. H04L 9/06; G06F 21/60

(52) U.S. Cl. CPC H04L 9/06; G06F 21/602; G06F 21/606

(57) ABSTRACT

This invention relates to a method and system using private key and algorithm for data protection during recording, storage, transmission, transaction, and display, and particularly to a method and system that provides no overhead, low latency, high speed, real time, and strong protection to any type of data, whether in the format of text, audio, photo, video, or mix of them. The invention provides means to a low cost system with great flexibility to support various personal or commercial interactive hardware and software applications that require security and protection of privacy of the user data.

This U.S. application is the official filing of the previously filed provisional U.S. patent application No. 61/981,854, filed on Apr. 21, 2014, entitled “Method and System of Real Time Data Protection for Transmission and Storage”, and incorporated herein by reference.

### BACKGROUND OF THE INVENTION

1. Field of the Invention

The present invention generally relates to data processing, and more particularly, to data protection and security with encryption and decryption.

2. Description of the Related and Prior Arts

Today, users make extensive use of encryption to securely send electronic message over the Internet and to perform electronic commerce at secure web sites. To protect the user data from various attacks, it is necessary to encrypt all important data for transmission and storage. Currently data are normally transmitted or stored over various media, such as internet data over optical fiber, instant messages between two mobile phones, or photos in PC hard-drive. In general, the critical data is encrypted by utilizing existing encryption schemes and transmitted over secure Internet protocols. Giving the explosion of the mobile data applications over the recent years, the demand for security of data and protection of privacy increases dramatically. Therefore, the demand for faster and lower cost real time solutions to daily user data applications becomes more and more important. Currently, there exist many different encryption and decryption algorithms for the secure transmission and storage of user data. The most well known one is the RSA algorithm, which was developed and named after the three mathematicians, Rivest, Shamir, and Adleman (RSA) from MIT university (Ref: U.S. Pat. No. 4,405,829). The several fundamental properties of the RSA algorithm are important to the encryption and decryption algorithm. For example, deciphering the encrypted form of a message yields the original message, and deciphering a message and then enciphering it results in the same original message. In addition, the actions of enciphering using a public key and deciphering using a private key are relatively easy to compute, but by publicly revealing the enciphering function (the public key) does not reveal any easy way to compute deciphering function (the private key) at all. Historically, RSA encryption algorithm uses up to 512-bit number for both the public and the private key, a number which has 154 digits in a decimal representation. In addition, both numbers are very large prime numbers. To process those numbers, it will take an large amount of computing power. In 1976, Dr. W. Diffie and Dr. M. E. Hellman published their original paper entitled “New Directions in Cryptography,” in IEEE Transactions on Information Theory, Volume 22, pp. 644-654, 1976, which provided a limited example of the public key system initially, and was later discovered to contain a complete public key system. Thus the Diffie-Hellman key exchange, together with its extension to digital signatures in the form of Digital Signature Standard (DSS), as adopted by the National Institute of Standards and Technology (NIST) in 1994, can do the same public key functions as RSA algorithm. The Diffie-Hellman algorithm is fundamentally identical to the RSA algorithm in terms of mathematical theory, but somewhat different in terms of implementation.

In both cases, its cryptography strength depends on how difficult it is for someone to compute a person's private number giving only the person's corresponding public number. For RSA, the strength is based on the difficulty of finding the prime factors of a large integer, while for Diffie-Hellman algorithm (Ref: U.S. Pat. No. 4,200,770), it depends on the difficulty of computing discrete logarithms in a finite field generated by a large prime number. In both cases, in order to be secure enough, the key size has to be very large, which requires a considerable amount of memory and computing power, and therefore hard to implement onto hardware for daily use by consumers on their ever small hand-held mobile devices.

Elliptic-curve cryptography (ECC) mathematics differ slightly from those of the RSA and Diffie-Hellman encryption schemes. Some descriptions can be found from the paper by Koblitz, N. (1987), entitled “Elliptic curve cryptosystems”, appeared on “Mathematics of Computation” 48 (177): 203-209. Within an ECC function, a group consists of a set of elements with custom defined arithmetic operations on these elements. A field is also a set of elements with custom defined arithmetic operations on these elements. The elements of an elliptic-curve group are pairs of numbers called points. The choice of the underlying field of the elliptic-curve group affects the number of points in the elliptic-curve group, and thus the key sizes, computational requirements, and the security. The underlying computation is an integer's scalar multiplication of a point on the curve. The security of the elliptic-curve systems relies on the difficulty of determining which integer was used in the multiplication, given the point and the result. It offers equivalent security to RSA and other public key techniques, while using smaller key sizes. In addition, the arithmetic operation may be easier to implement in hardware than arithmetic-modulo cryptography such as RSA and Diffie-Hellman schemes. Nevertheless, the requirements for a smaller but still a large key size in elliptic-curve encryption still requires considerable amount of computing power and memory in hardware or software implementations.

It is the objective of present invention to provide an encryption and decryption algorithm that offers data security and protection, which can be operated in real time, at wire speed and with minimum yet constant latency, without any additional overhead to the original data size, using either hardware or software implementations. It shall be independent of the physical medias that generates, carries, stores, or displays the data, and shall be transparent to standard digital transmission and storage protocols, and particularly, does not requires the considerable amount of computing power and enormous amount of memories.

As security is becoming a growing concern, more and more people are using private key encryption algorithm instead. This is especially true for personal and small business entities. The present invention presents a private key algorithm for data protection and security. The private key itself can be transmitted, stored using an existing public key method, or based on a prior agreement, or even transmit over the phone. Since the key can be processed offline, doing so enables a fast and secured way for data storage and transmission. Also due to the fact that the data protected by both the key and the algorithm, losing one of them will not jeopardize the data security.

The most closely resembling of the present invention is the RC4 scheme, which uses an algorithm to generate pseudo random numbers and XOR the data with these numbers. Some descriptions about RC4 algorithm can be found from the article by Scott R. Fluhrer, ltsik Mantin and Adi Shamir, entitled “Weaknesses in the Key Scheduling Algorithm of RC4” in Selected Areas in Cryptography, 2001, pp1-24. Since its random number generator is secret, it is hard to tell what it exactly is. The algorithm used in the present (our) invention differs from it because the present invention uses table driven pseudo random number generator. That is, the pseudo random number generator in the present invention is an array of random numbers. Since both the size and the content of the table are not fixed, it allows the users to make customized changes to this random number table, by changing the size, the content, or both. The algorithm in the present invention is more flexible and secured because other people do not know what the pseudo random number generator is used by the users, as it can be changed randomly at any time. In addition, when a pseudo random number is generated using the table, it can loop through the table many times. For example, for a table size of one million, looping through 1000 times means 0.1% of the table content is used for each pseudo random number generated. As such, changing 100 entries in the table would effectively changed 100*0.1%=10% of the encrypted data.

Since its random number generator is secret, it is hard to tell what it exactly is. The algorithm used in the present invention differs from it because the present invention uses table driven random number generator. That is, the random number generator in the present invention is an array of random numbers. Since both the size and the content are not fixed, it allows the users to make changes to this random number table, by changing the size, the content, or both. The algorithm in the present invention is more flexible and secured because other people do not know what the random number generator is used by the users, as it can be changed randomly at any time.

### SUMMARY OF THE INVENTION

The present invention provides an algorithm, apparatus and system for securing user data against eavesdropping and other unauthorized access to the original data when confidentiality and privacy are of the concern. More particularly, the present invention encrypts and decrypts the original user data based on the internal system based keys and the user defined keys. The data can only be decrypted by the original owner of the data with the correct keys and algorithms. So when the encrypted data is obtained by others through whatever means, the data cannot be decrypted without the original system defined keys, the owner defined keys and the encryption algorithm.

The present invention provides a mean to modify the encryption algorithm itself. As such, it added another layer of security to the data.

The present invention further includes an algorithm, apparatus and system that encrypts and decrypts the user data which the owner intends to communicate with another party with confidentiality and security. The data to be transmitted is encrypted and decrypted with an internally defined key by the sending and receiving systems, and a mutually agreed key between the two communicating parties. The data can only be decrypted by the intended party with the right receiving device and the correct mutually agreed key. No other person who accidentally receives the data or illegally obtained the data can decrypt the data without the right receiving device/algorithm and the correct key.

The present invention includes the algorithm, apparatus and system that performs the encryption and decryption in real time at wire speed without delay while the latency of the digital processing is minimum and stays constant during the encryption and decryption process. It simplifies the processing of encryption and decryption and requires significantly less computing power and device memory. This is critical to apply the encryption scheme to daily life of consumers, where the data protection is required in real time and at affordable cost. The present invention includes a software based algorithm that can be applied in many software based applications. More particularly, this algorithm can be used to create a secured file folder onto any storage and computing devices, such as computers and smart phones, in such that all the files, regardless of its types, can be encrypted once they are moved into the folder and decrypted once they are moved outside of the folder. It can also be used to create a texting or chatting application that provides the security protection to the text message or the chat messages sent between the two communicating parties.

The present invention also includes a hardware based solution that is based on an ASIC semiconductor chip purposely built with the algorithm from the present invention. With the ASIC chip, the encryption and decryption operates at wire speed without no overhead, which makes it compatible and transparent with other digital signal processing chips needed to perform other networking or storage functions, such as the framer chips, the optical coherent digital signal processing chip used in telecommunication, and the memory chips used for data storage. This purposely built ASIC chip with the present invention can be used in digital cameras for encrypting the recording videos and in smart mobile phones for encrypting the data into memory cards such as SD cards and USB drives. It can also be used in television (TV) and Set-Top Boxes (STB) for encrypting or masking the sensitive or inappropriate broadcasting or displaying contents. It can be used in bluetooth device to encrypt the real time live conversation between two parties to prevent a third party from tapping and listening to the conversation. In one exemplary example of the operation, one user can encrypt all data on the SD memory cards on his/her smart mobile phone automatically when the ASIC based on the present invention is used in the mobile phone. It will not affect any of his/her applications of the mobile phone, such as the playing of the videos, viewing of the files and etc. But when the mobile phone or the SD cards is lost or stolen, or when the files on the SD cards are obtained by unauthorized personnel, the true contents of the user data can still be protected since the files are encrypted in the first place. Furthermore, the owner of the SD cards or the lost mobile phones can quickly “delete” or “erase” or “change” the encryption key on the SD cards remotely. With this, even the unauthorized personnel somehow obtained the previous encryption key, the data can still not be decoded. Only when the SD cards are recovered and the encryption is reactivated, the data on the SD cards can be recovered again by the owner.

In another exemplary example of the operation, the user can decide which data needs critical attention and should be fully protected for confidentiality during the communication with the other party. In this case, the user can retrieve the encrypted data from the SD cards through the automatic decryption when taking the data out of the SD cards, and then re-encrypts the data with a new encryption key that is mutually agreed upon between the user and the corresponding party in the communication. No others can decode the data other than the intended receiving party, even if someone has tapped into the transmission process and obtained the data during the transmission.

### BRIEF DESCRIPTION OF THE DRAWING

So that the manner in which the above recited features of the present invention can be understood in detail, a more particular description of the invention, briefly summarized above, may be had by reference to embodiment, some of which are illustrated in the appended drawings. It is to be noted, however, that the appended drawings illustrate only typical embodiment of this invention and are therefore not to be considered limiting of its scope, for the invention may admit to other equally effective embodiment.

FIG. 1 shows the seven layer OSI model normally used for interconnection communication.

FIG. 2 shows the normal storage stack normally used in computing and storage devices.

FIG. 3 shows the normal data encryption and decryption process.

FIG. 4 shows the region allocations inside a SD memory card for critical data security and protection.

FIG. 5 shows the mobile commerce application between a user and a corresponding bank.

FIG. 6 shows the low level implementation of the present invention for securing the data on the storage media such as SD card.

FIG. 7 shows the block diagram of the hardware ASIC based implementation of the present invention.

FIG. 8 shows the use of the ASIC based solution into USB cable to protect data on the external storage media, such as external hard drive and USB storage media

FIG. 9 shows the use of the ASIC based solution on the optical modules or line cards to protect user data during optical transmission.

FIG. 10 shows the use of the ASIC based solution on the security cameras to protect still images or streaming videos for monitoring of the facilities such as homes, offices, public and private buildings.

FIG. 11 shows the use of the ASIC based solution on the television (TV), Set-Top Boxes (STB), remote control, or the video headend equipment from the video content providers to protect the data for display to viewers during the live TV broadcasting, Internet video streaming, home video playing, or computer screen mirroring.

FIG. 12 shows the building block diagram of the algorithm in the present invention.

FIG. 13 shows the detailed diagram of the encryption engine in the present invention.

FIG. 14 shows the detailed diagram of the decryption engine in the present invention.

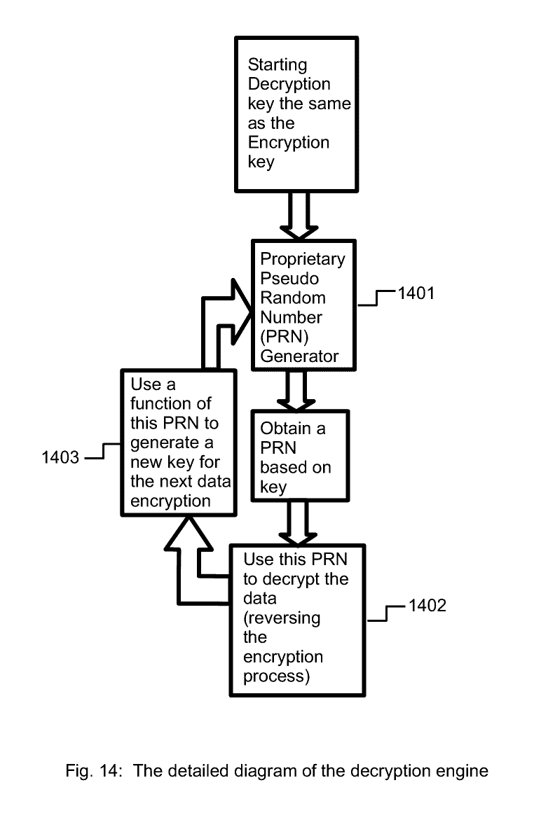

FIG. 15 shows one of the detailed schemes of the encryption in the present invention.

FIG. 16 shows the encryption algorithm in a flow chart.

### DETAILED DESCRIPTION OF THE INVENTION AND RELATED EMBODIMENTS

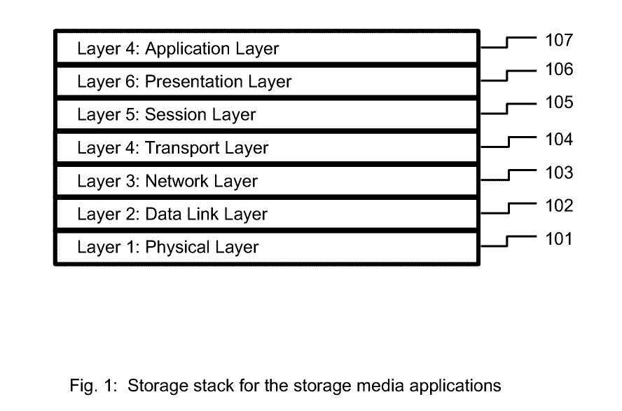

FIG. 1 is the illustration of the 7 layers of the OSI model normally used for interconnection communication. Commonly, encryption, decryption, and security features are implemented at Layer 6 (106), the presentation layer. Authentication and access permission control are implemented at Layer 5 (105), the session layer. However, more and more implementations are putting encryption, decryption, and security features into Layer 2 (102) and Layer 3 (103). In order to protect the data right at the storage media level so that the implementation becomes independent and transparent to other higher layers, the present invention encrypts and decrypts the data flowing into and out of the hardware storage media directly.

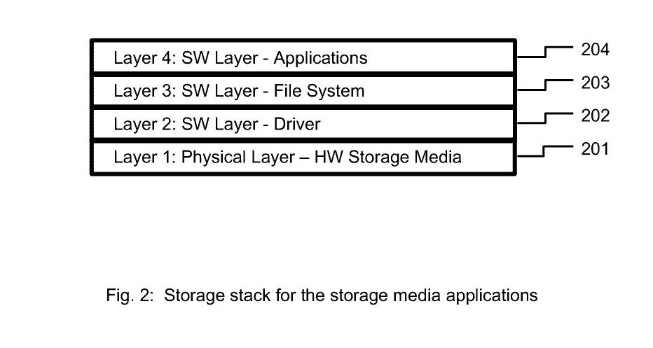

FIG. 2 shows the Storage Stack, where, 201 is the Physical Layer 1, which is the hardware storage media such as SD cards on smart mobile phones, that allows reading and writing by the present invention using block or sector addresses. 202 is the SW Driver Layer 2, which represents the storage media as a set of logical sectors. 203 is the SW File System Layer 3, which represents a logical disk as a collection of files and directories. 204 is the SW Application Layer 4, which interprets a file as a list of text lines, a picture or photo, a video, and etc. Data encryption and security can be implemented in any of these layers.

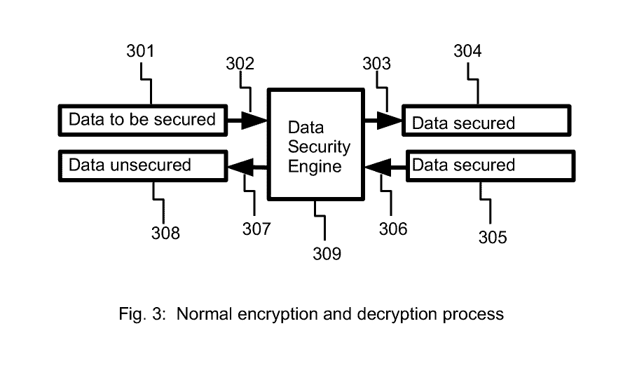

FIG. 3 shows the normal data encryption and decryption process. 310 is the data security engine, which encrypts data to be protected and decrypts data to be unsecured for normal use. 301 is the data that needs to be protected or secured. 302 is the data input into the data security engine for encryption. 303 is the output data connection line to send the secured data from the encryption engine to the storage media. 304 is the secured data itself from the engine stored in the storage media. 305 is the encrypted data stored in storage media that is ready to be sent through data connection line 306 to decryption engine. 307 is the decrypted that becomes unsecured or unprotected. 308 is the unsecured data output to be used by other application software or to be transmitted to either other parties or other encryption engine for additional encryption with mutually agreed key before the transmission to other intended recipients. This present invention is related to a light overhead encryption and decryption engine. That is, if the engine is implemented in hardware, it can achieve wire-speed. If it is implemented in software, it takes minimum CPU time and computing power to encrypt and decrypt data. The time needed for data to flow from 302 to 303 is minimum and remains constant, which is the same time for data to flow from 306 to 307. In this implementation, the present invention introduces no extra overhead during the encryption and decryption process. That means the data size of 304 is identical to the data size of 301, and the data size of 308 is identical to the data size of 305. Other software or hardware that continue to process the encrypted or decrypted data will not be impacted by the encryption and decryption process since the data size is not altered in any way in real time.

This present invention is related to a proprietary security engine, which allows users to make personal modifications so that it can not be easily decoded even if third party intercepts the secured data. In addition, the present algorithm is easily expandable such that one can increase the size of the security table, which contains some pre-determined numbers for the encryption engine, with minimum effect on the speed and latency. All it requires is slightly more memory, which is very inexpensive for the size of security tables required. The length of the security key can also be set to a large number if necessary. In order to decipher this engine, one needs to decipher the full security table of this engine, and to decipher the encryption key correctly. The encryption key is related also to the specific devices used by the user and the choice of the additional key by the user. By allowing the users to customize the security table and having a huge table for the engine, plus a encryption key that can be of any chosen size, it makes the engine very difficult to decipher.

Further more, the present invention is related to a flexible security engine. The present algorithm can be implemented in any layer of the seven layer OSI stacks. It can be implemented in the hardware layer, as shown in 101. It can also be implemented in any layer of the storage stack. For example, it can be implemented in the hardware storage media, as shown in 201, as one of the key embodiments. The present data protection scheme can also be deployed in the physical layer of any digital signal transportation system, such as the optical transmission links that carry high speed data at any rates like 2.5 Gb/s, 10 Gb/s, 40 Gb/s, 100 Gb/s, or 400 Gb/s. In the present invention, a proprietary key exchange algorithm is not included. Therefore, the standard key exchange algorithm, such as Diffie-Hellman key exchange, can be used together with this security engine.

One of the major concerns of data security and protection is the unauthorized person who manages to get into the system and obtains the critical data within the system without being detected by users. The present invention provides a scheme to securely store critical data in such way that it would allow communication of critical data between parties, without being processed in plain viewable and unprotected form. This is achieved by provisioning the storage media, such as flash or hard drive into multiple regions, and using the proprietary data security scheme of the present invention to protect the critical data.

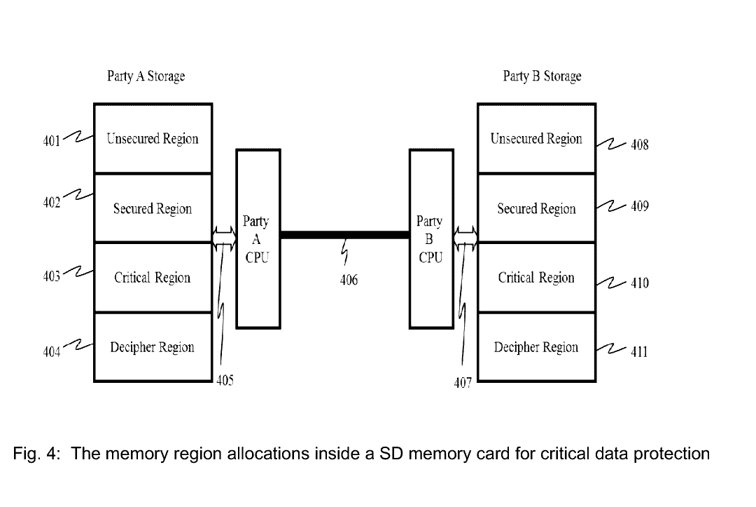

One of the preferred embodiments of the present invention is shown in FIG. 4, which provides a way to protect data inside a system, between systems as well as during inter-system transmission. The present invention divides the data storage media from each party (Party A and Party B in FIG. 4) into four regions, namely, Unsecured Region (401 & 408), Secured Region (402 & 409), Critical Region (403 & 410), and Decipher Region (404 & 411). The unsecured Region is used to store normal data that do not need to be protected, Secured Region is used to store data to be protected. When data are stored in this region, they are encrypted with the Secured Region Key. When they are retrieved, they are decrypted with the same Secured Region Key. So when the data is retrieved by the processor (CPU), the data will be presented in the original form. That is, they are readable by its own CPU. Critical Region is used to store critical data, such that they will not be readable even when the data is retrieved by the user's own processor (CPU) in the device. When the data are stored in this region, they are encrypted with the Secured Region Key. When data are retrieved from Critical Region, they will be first decrypted with the same Secured Region Key, then they are further encrypted with a pre-provisioned Critical Region Key. Since the retrieved data is encrypted, they are not readable by the user's own CPU. Decipher Region is used to decipher data stored in Critical Region. When data is stored into the Decipher Region, these data will be deciphered with the Decipher Region Key first, then they will be further encrypted with the Secured Region Key. When data are retrieved from this region, they will be decrypted with the Secured Region Key. The Critical Region and Decipher Region are used for the communication with another party for the critical data that requires high security for data protection. The invention can be implemented with the present proprietary data protection algorithm in hardware with wire-speed and constant latency. Since all of the protected data in the storage are encrypted with the same key (Secured Region Key), it can be “killed” by remotely erasing the Secured Region Key through the Internet or wireless network, if the storage media itself is lost or stolen, or the content on it is stolen by illegal means.

Furthermore the content on the lost or stolen storage media can be “restored” by provisioning the correct Secured Region Key again by the user, if it is recovered or deemed safe to be used by others. Accordingly to one of the preferred embodiments of the present invention, this invention can be used for mobile based commence, as shown in FIG. 4. Assume that Party A is a mobile phone user and Party B is a payment center in the bank.

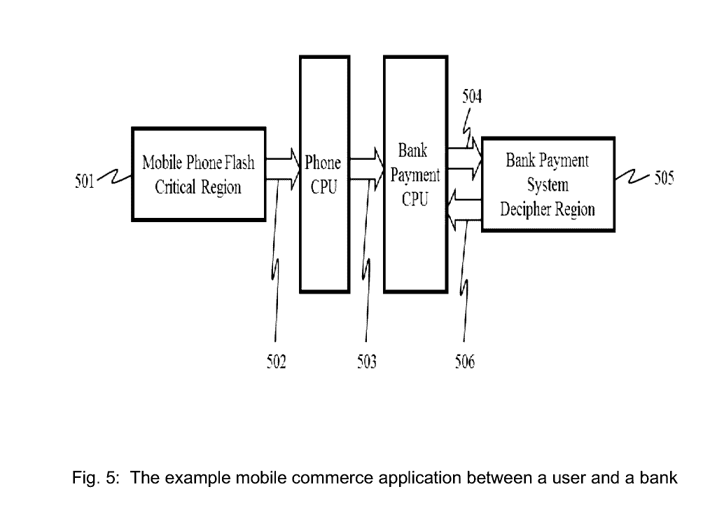

FIG. 5 is the data flow of making a payment to a bank. As shown, 501 is the user's personal confidential data related to the bank transaction, such as user name and password, bank account number, credit card number, and etc. which are stored in the Critical Region of the mobile device memory (flash). This region is protected with mobile device Secured Region Key for storage and bank's mutually agreed Payment Security Key for data retrieval. 502 shows the transmission process between the Critical Region and processor of the mobile phone (CPU). When payment is made, personal data is retrieved from the Critical Region by the mobile device processor (phone CPU). Since the data is encrypted when it is stored in the storage media, they are not readable. When they are retrieved by the processor (phone CPU), they are also encrypted with bank's Payment Secured Region Key. Therefore, no one can see the personal data either from the user's phone or by tapping somewhere along the transmission line. In the present invention, Malware in the mobile device cannot read and decrypt the personal data without knowing the bank's Payment Security Region Key. 503 is the transmission of the encrypted personal data from the cell phone user to the bank payment system. During the transmission, data are protected with bank Payment Secured Region Key. So they are not readable by anyone other than the bank. Any tap into the transmission media cannot read the encrypted personal data. 504 is the bank's system encryption processor based on the present invention that stores the encrypted personal data into the Decipher Region for future information retrieval. 505 is the bank's Payment System Decipher Region that is equipped with bank's Payment Security Key for deciphering when the personal data is stored. And they are protected with bank's Secured Region Key for storage and retrieval. 506 is the bank's Payment System decryption processor based on the present invention that retrieves personal data from the Decipher Region and sent to CPU for processing. When the personal data is retrieved, they are in readable form.

The present invention related to the data security and protection algorithm can be implemented in either software or hardware. If it is implemented in software, it can be implemented as a driver library such that the Operating System (OS) can access its interface (API), but the user or the developer of the software cannot see the implementation detail and the algorithm itself. Since it is implemented in the lowest level of the software, it can be used in any layer of the software, either be the networking stack or the storage stack. The present algorithm is light-weighted in required additional processing power and with no overhead in data size, therefore it poses minimum impact on any of the system softwares.

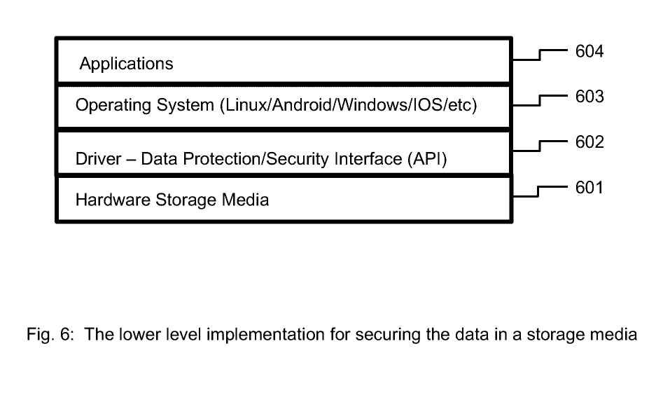

FIG. 6 shows one of the preferred embodiments of present invention to implement it in software and operating system. 601 is the hardware storage media, such a flash, hard driver, memory (DRAM/DDR). 602 is the drivers include the software implementation of the light-weight-no-overhead data security and protection algorithm of the present invention. 603 is the Operating Systems (RTOS). 604 is the Applications that can make use of the present invention related to data security and protection algorithm.

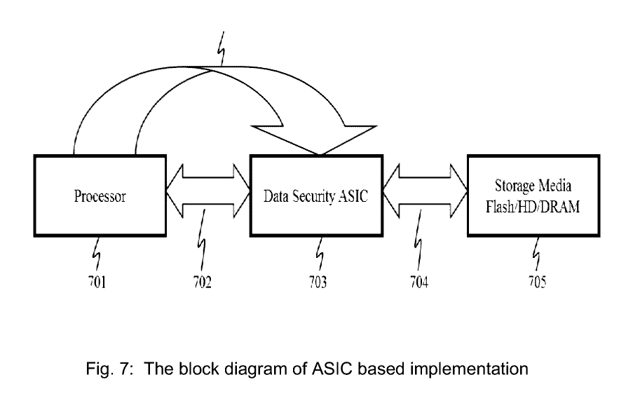

FIG. 7 shows one of the preferred embodiments of the current invention based on an ASIC configuration for storage. The same scheme can be used for data transmission protection as well. FIG. 7 shows an embedded configuration of the ASIC of the algorithm of the present invention. Here are the detailed descriptions of each block. 701 is the processor CPU that accesses storage media 705. Since the ASIC implementation of the present algorithm exhibits constant latency with no overhead, there is no need to change any existing application software that is to be used to access and process the original data. 702 shows the data connection from processor to the encryption and decryption engine embedded in the ASIC chip 703. When device CPU accesses the storage media, it actually accesses the ASIC first. 703 is the ASIC implementation of the algorithm of the present invention. 704 shows that ASIC accesses to the actually storage media. In this embodiment, the AISC serves as a proxy for the device CPU to access the actual storage device where data is to be located. 705 is the hardware storage device. 706 is a new interface for the device processor CPU to configure the ASIC. Many other features can be designed into the ASIC, such as the support for I2C. This is the interface to allow the device CPU to configure the Secured Region Key, the Critical Region Key, and the Decipher Region Key. Instead of embedding the chip into the hardware design of the application system, one can put the ASIC into external uses as well.

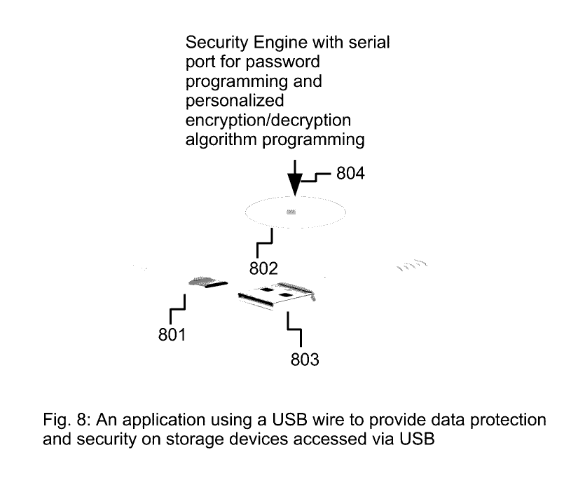

FIG. 8 shows another embodiment of the ASIC of the present invention of the algorithm into an USB cable to protect external storage devices. As shown in FIG. 8, 801 is the Mini USB connector to external storage devices, such as Flash, Hard-Drive, and etc. Different type of connectors can also be used. It is not limited to the mini USB connector. 802 shows that the ASIC of the present invention of the algorithm is inserted in between the USB cable. 803 is the USB connector to a system device, such as PC, MAC, iPad, mobile phones, and etc. Different type of connectors can also be used. It is not limited to the USB connector. 804 shows a control port that allows a system device to configure the ASIC, such as setting the region boundaries, setting the protection keys to different regions. This can be a simple serial port to be connected to a PC or MAC, or other type of connectors for different system devices, or one can use the same mini USB port 801 to control the setting on the ASIC through interface connection 804. It is possible to implement one ASIC per type of system and storage device. This is an inexpensive way to protect external storage devices, such as flash thumb drives or external hard drive without changing the systems or the storage devices themselves. The user needs to simply switch the normal USB cable to a new USB cable that utilizes the present invention and therefore enables the data protection for any storage device.

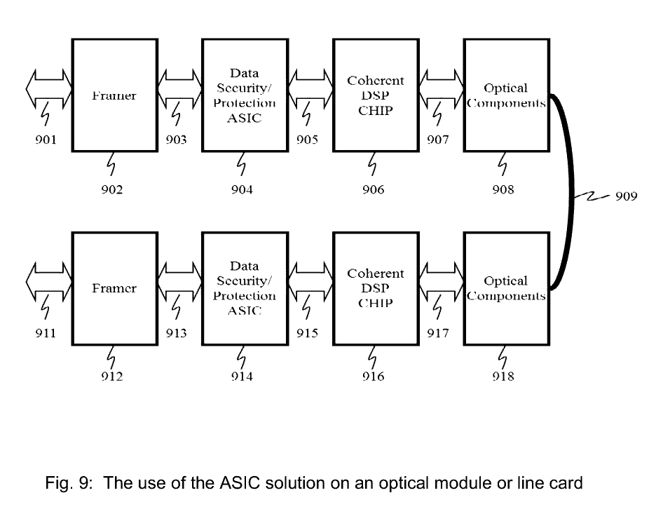

FIG. 9 shows another embodiment of the present invention that protects user data during physical transmission. In this example, the method and algorithm of the present invention is implemented into a long haul coherent optical transmission system. As shown in FIGS. 9, 901 and 911 are the user data to be transmitted and received from the optical coherent transmission system, respectively. 902 and 912 are the framer used to put the data into various standard based frames. 903 and 913 are the data to be forwarded to and retrieved from the encryption and decryption ASIC based on the present invention, respectively. 904 and 914 are the encryption and decryption ASIC based on the present invention. 905 and 915 are the data to be forwarded to and retrieved from the coherent digital signal processing (DSP) ASIC chip for optical coherent processing, respectively. 906 and 916 are the optical coherent DSP ASICs.907 and 917 are the data to be passed to and retrieved from optical components, respectively. 908 and 918 are the transmitting and receiving optical components, respectively. 909 are the optical fibers (or fiber systems) for physical transmission of data.

Such a real time data protection system is made possible because of the fact that the data protection ASIC based on the present invention requires no overhead and exhibits constant latency during the protection process. First of all, since there is no overhead during the data encryption and decryption process, the size of the data out of the framer is of the same size of the data to be passed into the coherent DSP ASIC. Other than bits in the data are changed, the size of the data remains the same. Therefore the coherent DSP ASIC acts as if it continuously gets the data directly from the framer without the presence of the data protection ASIC. Secondly, since the latency of encryption of the data at the transmitting end is the same as the decryption at the receiving end, there is no timing issue that would cause FIFO (First In First Out) overflow or underflow in the optical coherent DSP ASIC. Thirdly, since the data protection scheme requires no significant amount of calculating and processing power, the encryption and decryption is achieved in wire-speed, without causing data starvation to either the framer or the coherent digital signal processing (DSP) ASIC. The wire-speed can be achieved from low speed to high speed based on the implementation of the data protection ASIC. For example, the existing wire speed of 100 Gb/s to 400 Gb/s in coherent optical communications can be easily supported by the present invention. Additionally, the transmission system does not need to be coherent, or optical. Any type of digital transmission system at any speed can use the present invention to provide data protection during the transmission of the user data over the physical media. The transmission media can also be wireline or wireless. The protection scheme is also independent of the transmission protocols. Since the data passing through the physical transmission media is also encrypted in real time between the two end terminals or end users, the data is therefore well protected from tapping and monitoring. For example, the optical fiber (909) in FIG. 9 or any transmission media used to transport the user data, whether through wireline or wireless means, is somehow tapped and monitored by an interceptor, only the encrypted data can be obtained by the interceptor. The data can only be decrypted with the intended end user's own encryption key and therefore the user raw data is protected even when the transmission path is somehow compromised.

Another embodiment of the present invention is the security monitoring system, for home, office, or public facilities. Currently, most security systems consist of cameras located throughout the different locations within the protected facilities and transmit still images or continuous video streams to a gateway inside the facility through either wireline or wireless means. The gateway collects all of the feeds of videos and images and transmits them to the owner's computers, cell phones or mobile devices over the internet. However, there are some possibilities that some others can tap into the transmission path, either through the physical tapping to the cameras, or the tapping into the WiFi networks used for the cameras to connected back to the gateway of the facility, or the unauthorized access to the Internet connection or the user's devices. If the videos and the images from the cameras are not protected, the one who taps into the system can view what is going on inside the facility, just like the owner. This makes the security camera systems less security since it provides an inside close look into the facility to the hackers who tap into the camera monitoring system.

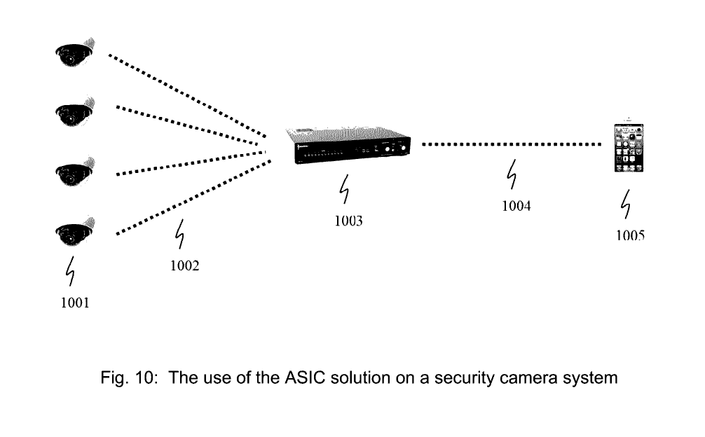

This is shown in FIG. 10. 1001 are the facility security monitoring cameras. 1002 are the images and videos transmitted to the facility gateway. 1003 is the facility security monitoring gateway. 1004 are the data, images and videos transmitted to the owner's receiving devices. 1005 are the owner's receiving monitoring devices, such as computers, mobile phone or any smart computing devices. Without data protection, signals at 1002 and 1004 can easily be hacked and hackers can invade one's privacy. This case can be prevented by implementing the data protection algorithm based on the present invention directly into the monitoring cameras, facility gateways and the receiving mobile or smart computing devices, through either the hardware implementation using the data protection ASIC, or the software implementation based on the present real time encryption and decryption algorithm, or both in the same system. This implementation is applicable to all transmission systems including wireline, wireless, WiFi connection and etc.

Another embodiment of the present invention is the application to the real time displaying system, such as the TV broadcast system, and the video playing systems. For example, if the broadcasters encrypt their broadcast signals with this scheme and their own keys, only the TVs or set-top boxes equipped with this scheme and have the correct passwords can view the contents. Due to the no-overhead nature of this scheme, it will not increase the broadcasters' cost. Since this scheme can be implemented into data protection ASIC, it can easily be put into TVs or set-top boxes with minimum cost. This provides a way to protect contents. It can also be deployed in satellites to dishes system.

This scheme can also be used for parental control. TV display contents, even a small portion of the scenes, that should be viewed with discretion or parent control, can be instantly encrypted with this scheme and a password, if the TV has equipped with this capability by utilizing the present invention. Only those who know the password can view these restricted contents. One implementation is to have a special sequence of signals to indicate the starting and ending of the restricted content. If the TV (or set-top box) is equipped with the data protection ASIC of the present invention and enabled with the correct password, it can display the content. Otherwise, the content will be masked and cannot be displayed to the viewer.

Another way to implement parental control is to use the remote control of the TV (or set-top box) to turn on the encryption and decryption instantly. When adults are watching TV with kids, if some inappropriate contents suddenly show up on TV, the adult can instantly press the encryption button to mask out the content without turning off the TV. One can turn off the encryption mask by pressing the decryption button whenever the inappropriate content is believed to be gone.

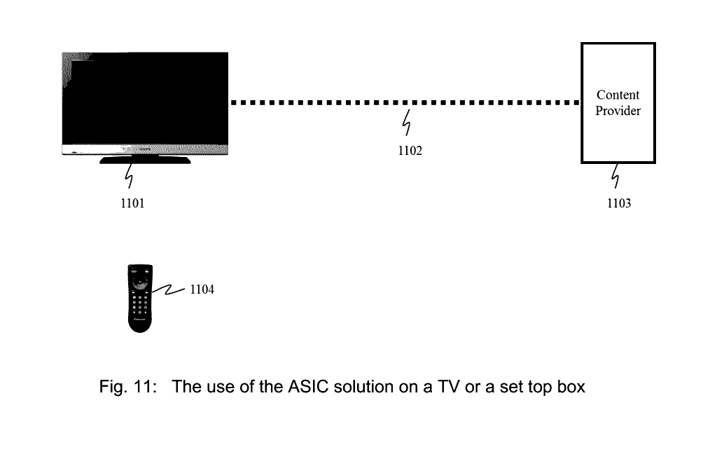

These examples are shown in FIG. 11. 1101 is the TV or set-top box with the data protection capability based on the present invention. 1102 is the content delivered that uses the data protection scheme, with start and stop indicators such that devices in 1101 can automatically encrypt and decrypt the associated content. 1103 are the content providers, such as cable operators who use the present invention to protect their contents and/or to mask contents that are sensitive to some viewers. 1104 is the TV or Set Top Box remote control that can send signals to the content display devices (in this case, TV) to encrypt or decrypt the sensitive contents whenever it is needed.

Another embodiment of the present invention is to put this scheme into an instant message service or peer to peer chat service. In these cases, the instant messages or the chat messages are encrypted with the data protection scheme of the present invention and with customized keys mutually agreed by the two end users. In this system, only those who know the customized keys can view the chat contents. This can be used in content subscription service.

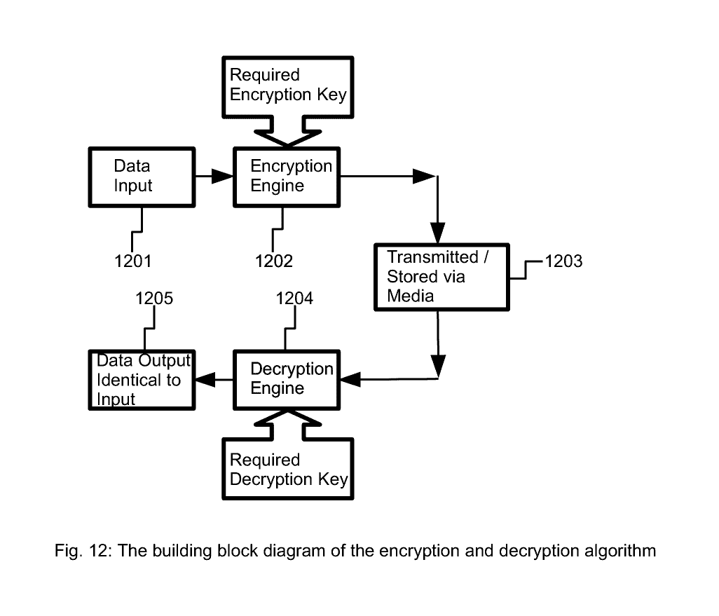

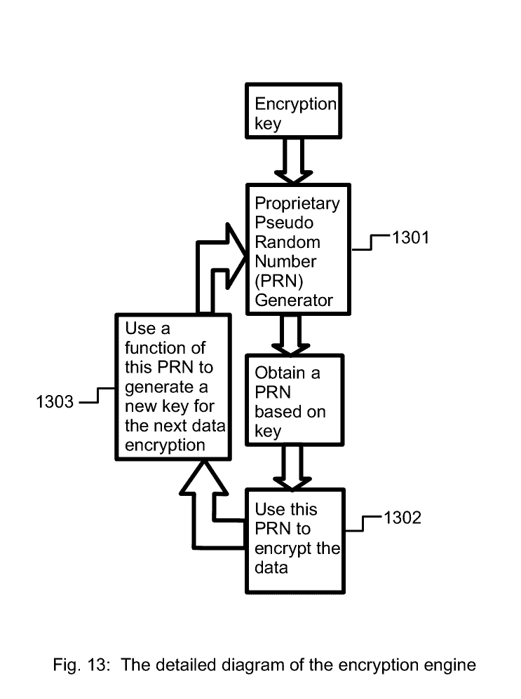

In terms of the detailed implementation of the real time encryption and decryption algorithm, FIG. 12 shows the flow chart of the encryption. First, 1201 is the raw user data input, which passes through 1202 which is the encrypting engine with very short constant latency, in terms of microseconds or mini-seconds. Then the encrypted data is passed through 1203 to the transmission and storage media. At the receiving and retrieving end, the data pass through 1204 which is the decrypting engine, that restores the data back to the original input form with very short constant latency, the same as in the encryption engine. Finally, the output data (identical to the input data) is forwarded to 1205 which is the receiving and retrieving original data for end user. In more detail, still referring to the present invention of FIG. 12 and FIG. 13, the encryption engine at 1202 includes a proprietary pseudo random number generator 1301 in FIG. 13 that accepts a “key” as the starting number and the size of the “random number field”. This engine makes use of the pseudo random number generator 1301 in multiple iterations to encrypt the data. At the other end 1204 of the transmission and storage media, a reversal of the encrypting process (called decryption engine) will decipher the data and restore them to the original form of the input 1201. The proprietary pseudo random number generator scheme makes use of pre-generated large amount of random numbers. When floating point random numbers are used, it will provide maximum security since the number of real numbers between 0 and 1 can be viewed as infinity. In reality, depending on the security and latency requirement, integers can be used. The amount of random numbers can also be chosen based on the security and physical, such as memory, requirement. The more the random numbers used, the more secured the engine will be. Since these proprietary random numbers are pre-generated, it will reduce the time to encrypt and decrypt the data. Hence, the latency is constant and small, in terms of microseconds to mini seconds. In addition, the encryption and decryption engines also allow these pre-generated random numbers being able to be self-modified and user provisioned. In this way, even the device maker may not be able to decipher the encrypted data. This adds another layer of security for the users of this engine.

In further detail, still referring to the invention in FIG. 12, the encryption engine 1202 and decryption engine 1204 are based on a proprietary pseudo random number generator 1301 which is not decipherable. When the pseudo random number generator 1301 is based on a large number of pre-generated random number, from millions to billions or even more, depending on the size of the memory used, plus varying the used field size, which defines how many of the random numbers are used each time, plus the capability of self-modifying and user-provisioning of the pre-generated random numbers, this makes it virtually very difficult to decipher this random number generator 1206, even for the manufacturers of these engines. As long as these random numbers are matched between the transmitting and storing side 1202 and the receiving and retrieving side 1204, the data can be safely recovered at receiving and retrieving end. Here are the pseudo codes used for the proprietary pseudo random number generator 1301 and 1401 and the next key in 1303:

```
#define PRN_SIZE 1024*1024 // Should be of larger size
float generatedPRN[PRN_SIZE] = {prn0, prn1, ..., prnPRN_SIZE};
// prn0, prn1, ..., prnPRN_SIZE are pre-generated positive random float
numbers
float getPRN(unsigned int key)
{
  if (key >= PRN_SIZE)
  key = PRN_SIZE − 1;
  return generatedPRN[key];
}
unsigned int getNextKey(unsigned int key, unsigned int usedSize)
{
  if (key >= PRN_SIZE) key = PRN_SIZE − 1;
  if (usedSize >= PRN_SIZE) useSize = PRN_SIZE − 1;
  return (unsigned int)(usedSize*generatedPRN[key]);
}
int modifyGeneratedPRN(unsigned int index, float newPrn)
{
  int rc = 1;
  if (index >= PRN_SIZE)
  {
  index = PRN_SIZE − 1;
  rc = 0;
  }
  generatedPRN[index] = newPrn;
  return rc;
}
```

The construction details of the invention as shown in FIG. 12 are that the input data is encrypted based on a proprietary pseudo random number generator 1301. There are many ways to encrypt data 1302 once there is a pseudo random number generator 1301. The current invention is presenting one of such uses. First, the current invention can make use of the pseudo random number generator 1301 in FIG. 13 to modify of bits of the input data randomly to make it “not recognizable”.

For example, if the input data is a chat message of characters, changing random number of bits of the sentence will make the data not readable and not recognizable. This can be done via an XOR function. Afterward, each character of the modified string can go through a circular bit shifting random number of times. The following is an example implementation of the Decryption Engine 1204:

```
//Assume a text string of 128 txt[128] as the input to the Encryption
Engine. The encryption key is provisioned as Key
#define TEXT_SIZE 128 char txt[TEXT_SIZE]; // input as global
variable
int encryptEngine(unsigned int key) {
  unsigned int nextKey; float prn = getPRN(key);
  unsigned int tmp;
  for (int =0; i<TEXT_SIZE; i++) {
  nextKey = (unsigned int)(prn*PRN_SIZE);
  txt[i] = txt[i] \hat{ } (1<<(nextKey & 0xFF));
  prn = getPRN(nextKey);
  nextKey = (unsigned int)(prn*PRN_SIZE);
  tmp = nextKey & 0xFF;
  txt[i] = ((txt[i]<<tmp) & 0xFF) + ((txt[i]>>(8-tmp))&0xFF);
  prn = getPRN(nextKey);
  }
}
```

In this example, only one bit is changed per character. In actual implementation, multiple bits can be changed randomly using getPRN function. All are depended on the level of security required and the engine speed used. ModifyGeneratedPRN function can be used to change the pre-generated random numbers via user provisioning or self-modification within the encryption engine and decryption engine. In this way, even the device maker, who put in the original pre-generated random number, will not know what the pseudo random number generator really is. It is strongly recommended to device makers having such capability implemented in the device. It is achievable if the engines are implemented in FPGA or EEPROM. The decryption engine is the reversed of the encryption engine. It can easily be done based on the codes above. This is just an example of implementation. The actual implementation of the encryption and decryption engines can be different.

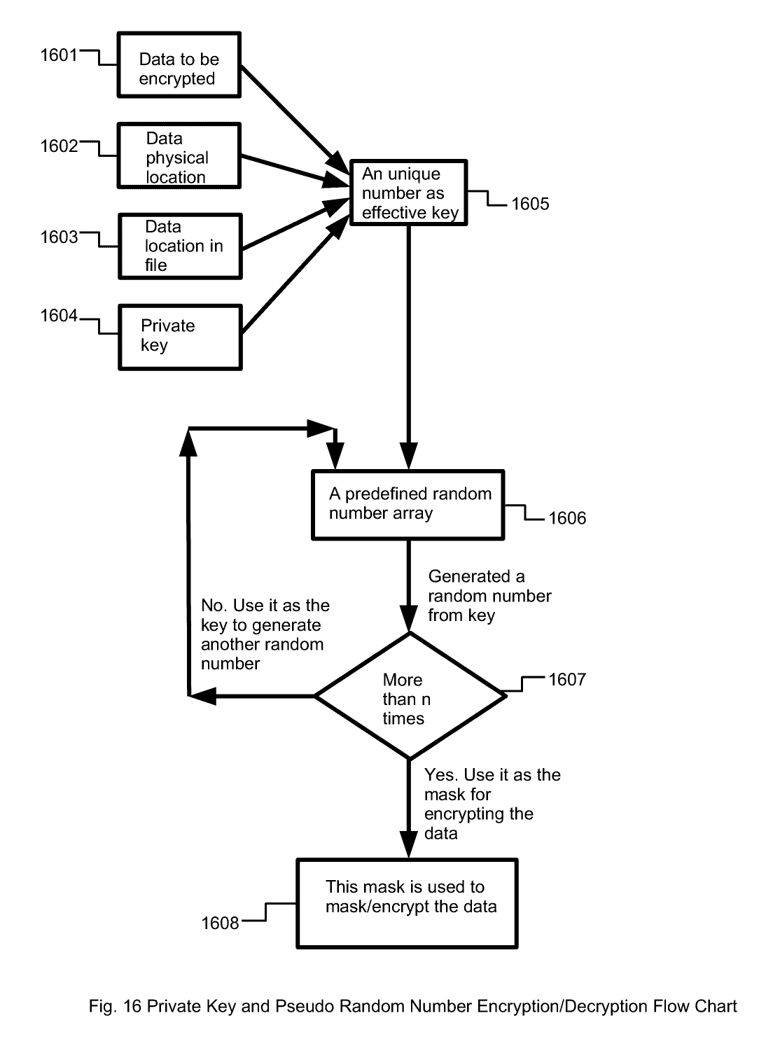

A more detailed flow chart of the cryptography algorithm in the present invention is shown in FIG. 16. (1601) is the input stream of data to be encrypted. (1602) is the physical location of the data, such as address 0x12345678 in the storage media, or memory. (1603) is the data location within the file, such as the first byte of the file, the second byte of the file, and so on. (1604) is the private key used to encrypt this file. All of these information can be used as the input to generate an effective key (an unique number) as in (1605), that feeds into the cryptographic algorithm. The algorithm uses this effective key (1605) to hash into the pseudo random number array (1606) to generate another number. The newly generated number can also be used as the new effective key; and this process is repeated N times (1607) to generate the final number (1608), where it is used to XOR the input data to generate the encrypted data, while N can be of any integer number. Since there is no complex computation involved, the algorithm is fast and of constant latency.

In order to decode a message of 128 characters (bytes), one needs to try {POW(2, (8*128)) for bit modification]*[POW(8(for bit shifting of each byte),128 (for length of the message))]}=7.0832716E423. So it is very expensive to decode a 128 characters message. With so much possibility, there is very little chance to know what the original message actually is. It is obvious that the larger the input data, the more work is required to decode it.

If this engine is applied to optical or electrical data transmission, the bit modification can apply to the headers and data so that it is not easily reconstructed by hackers, the whole transmission can be fully protected. Since the encryption and decryption latency is constant and small, this engine can be used for high speed transmission. The decryption process is the reversed of the encryption process. First, the bit modifications are generated using the same starting key, and saved. Then the bytes/words are shifted in the reversed direction to restore the data stream. Afterward, the engine applies the bit modifications using the XOR to recover the original data.

Still referring to the present invention shown in FIG. 12, users can provision the key at both transmitting and storing and receiving and viewing ends to ensure the receiving/retrieving end can recover the data. If overhead is allowed during transmission and storage, it is wise to include the starting key and the size of the random numbers used in each transmission/storage and then keep changing the key and size using the proprietary pseudo random number generator. This will eliminate the user provisioning work and it will make the encryption harder to be cracked. On top of this, one can also add self-modification to some of the pre-generated random numbers periodically. As long as the modifications will not change the randomness of the generator, it will provide extra protection to the data. Beside, different application of this proprietary pseudo random number generator can be used to encrypt and decrypt data. For instance, one can do circular shifting random number of bits of the full data size at each byte. This can increase the security of the data drastically. One can also do the shifting first; then the bit modification. Other scheme that makes use of random number can be used to encrypt and decrypt the data. It is not limited to the suggestion above.

One of the advantages of the present invention includes, without limitation to the transmission and storage media, is that the engine can be used from small message transmission and storage, such as chats between mobile phones, to large amount and high speed data transmission, such in high speed optical communication equipment, due to the nature of small or no overhead, and small constant latency in encryption and decryption. Encryption and decryption are common. But an engine with no overhead and constant small latency makes it advantageous, especially for high speed data transmission. In addition, it is effective and less expensive. It can be implemented in software for chats in mobile phone application. It can also be implemented in a small ASIC chip, an EEPROM, or a FPGA inside a high speed transmission system.

The present invention requires the minimum amount of computation and memory to complete the encryption and decryption, which is based on logical operation with the binary data with small key sizes. When data is written into a storage device, it passes through the security engine of the present invention, which will encrypt the data but not the protocol carrying and writing the data. For example, when a data file is written to a storage device, such as a thumb-drive or a hard drive via a USB connection, the data file are transmitted along with the USB control protocol. In hardware, the present invention can have one USB transceiver that acts as receiver to receive the data from the host. Then the received data are passed through a encryption engine. Finally, the encrypted data are handed over to another USB transceiver, which acts as host to send the data to the other end. On the reversed direction, the data passed through a decryption engine instead. It is painless to use because the encryption and decryption depend on the physical engine. The user will have a default security engine installed. Once the password is set, the encryption will start. Even a user who forgets the password, can still retrieve the data with the same physical engine, in most case, a simple wire, such as an USB wire. A serial port to the security engine provides a means to input password and even reprogram the security engine to one's own security algorithm. Such a device can be designed elegantly such that it looks like a normal USB cable as shown in FIG. 8 and the serial port can be similar to many smart watch serial port that would be concealed to be almost invisible.

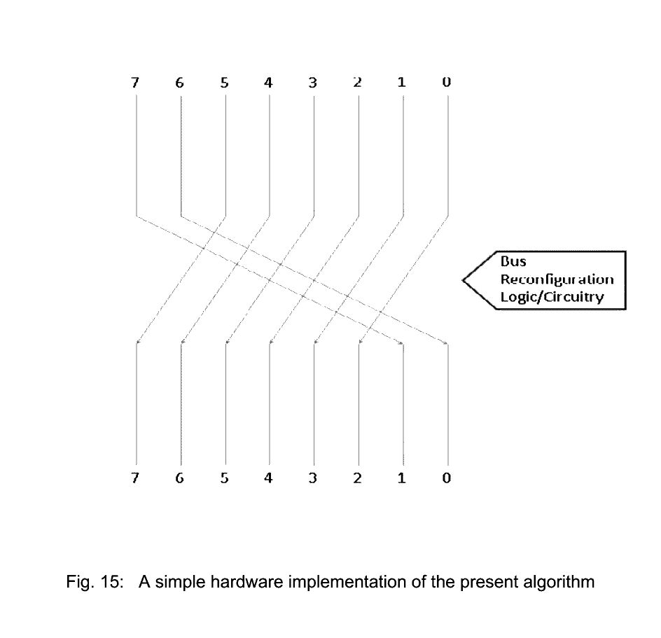

Because of the simplicity of this encryption and decryption engine, it could be implemented in data bus rate. That is, a simple logic circuitry can be placed in the data bus between CPU and the memory unit so that it could do the simple encryption based on, such as the address and a provisioned key, such as the serial number of the equipment. For example, circular left shift two bits of an 8 bit data bus can be implemented as shown in FIG. 15.

With this design, the encryption/decryption engines are not limited to what we have preloaded. The RSA and Diffie-Hellman schemes rely on the fact that it is NP-complete to solve the problem. So it requires unrealistic computer power to solve the keys. We advocate that one can use its own private algorithm that no one else can solve it since they don't know the algorithm itself. So the present algorithm is not limited to the functionalities and embodiments presented here. It can also handle private algorithms, as long as the device has enough buffer to store the “receiver” data before passing them through the crypto/security engine. The algorithm used in present invention here is a table driven translation, based on the crypto/security key of unspecified length, with the ability of letting users to change the table. Since the size of the table and the crypto/security key can be of any size, it makes the algorithm look like another NP-complete problem, where NP stands for “Non Deterministic Polynomial Time”. It is not NP-complete if the algorithm is known. Therefore, the present invention allows third parties to use their own crypto/security engines. It is obvious from the present architecture, the cost of such device is minimum. The present invention provides the application for users to set/change passwords and/or reprogram the security engine. The security engine is powered by USB host. Since the encryption and decryption are symmetrical, labels are needed to remember which end is connected to the storage device and which one is to the PC. Applications are provided for the security engine programming.

It is easy to see that the number of reconfigurations, as in 15, is limited. Therefore, these circuitries (circular left shifted by 0, 1, 2, 3, 4, 5, 6, 7) can be implemented and activated based on a given key. The only requirement is that key used to manipulate this piece of data is recoverable. One example is to use formula to generate key based on the address and another provisioned number, such as serial number. If it is possible, circuitry of XOR of certain bit should also be implemented in data bus rate as part of the logic. This will make the encryption stronger.

With such encryption and decryption engine chip, any storage media, such as DRAM or flash, and hard-drive, can be encrypted. These encrypted memory devices can be used in many different applications. For example, if an encrypted and detachable SD flash is used in a mobile phone, any APP bought using this mobile phone and stored in this flash will not be portable to another mobile phone of the same model since the provisioned key (such as the serial number) will not be the same. If mobile phone memory is protected with such encryption chip, the phone can be disabled remotely by changing the provisioned key. So any files on the SD cards inside the mobile phone become not not useful anymore even if the person who obtains the files and mobile phones also processes the previous decryption key.

While particular embodiments according to the present invention have been illustrated and described above, those skilled in the art understand that the invention can take a variety of forms and embodiments within the scope of the appended claims.

What is claimed here is:

1. A data protection algorithm, apparatus and system, comprising the use of an time efficient encryption and decryption engine that provides security protection to user data.

2. The method, apparatus and system of claim 1, wherein the data protection is achieved at wire speed in real time and only exhibit a small and constant latency.

3. The method, apparatus and system of claim 1, wherein the encryption and decryption is independent of wire speed. The method is applicable to any low speed and high speed applications, such as at a line transmission rate of 10 Mb/s, 100 Mb/s, 1 Gb/s, 10 Gb/s, 40 Gb/s, 100 Gb/s, 400 Gb/s, and beyond.

4. The method, apparatus and system of claim 1, wherein the encrypted data file and the decrypted data file are of the same data file size as that of the original user data file. In another word, there is no memory overhead required for the data protection process.

5. The method, apparatus and system of claim 1, wherein the application of the present invention is independent of and transparent to the existing software or hardware applications, whether they are based on various different digital processing technologies or industry standard protocols.

6. The method, apparatus and system of claim 1, wherein the encryption and decryption is independent of the data file format. The user file can be of the format of text, document, audio, photo, video, streamed video, or any combination of them.

7. The method, apparatus and system of claim 1, wherein the encryption and decryption method is applicable to any portion of a user data file or any portion of a streaming or broadcasting video. The user is able to control exactly when and where to start the encryption and decryption within a data file or at a specific time moment.

8. The method, apparatus and system of claim 1, wherein the encryption and decryption are independent of physical storage media where the user data is stored. Data sent to or retrieved from any type of digital storage medial can be protected by the use of the present invention.

9. A method, apparatus and system of encryption and decryption that can be used for storing and retrieving protected data to and from any storage media, sending and receiving protected data to and from any terminal devices, controlling and filtering protected data to and from any text, audio, and video recording and displaying devices.

10. A method, apparatus and system of real time encryption and decryption, according to claim 8, wherein the storage media can be any type of USB devices, external hard drives, SD memory cards, and etc.

11. A method, apparatus and system of encryption and decryption, according to claim 9, wherein the terminal devices used by users to transmit and receive protected data can be computers, mobile phones, smart devices, Bluetooth devices, NFC (near field communication) devices, infrared devices, WiFi enabled devices, or any other routing, switching, and transporting devices.

12. A method, apparatus and system of encryption and decryption, according to claim 9, that is used for protection of data during the process of video recording and transmission, when digital cameras are used for the security monitoring of home, office, or any public or private facility. The video recorded by the camera is encrypted in real time in the camera before it is transmitted to the receiving gateway through wired or wireless network and then sent over the Internet to the owner's viewing devices such as computers or smart mobile phones.

13. A method, apparatus and system of encryption and decryption, according to claim 9, that is used for selective control of digital video display onto any viewing devices. The user or the content provider can control and mask out the undesired, inappropriate, sensitive, or unauthorized contents in real time during video playing onto the viewing devices or live broadcasting onto television (TV).

14. A method, apparatus and method of encryption and decryption, according to claim 8, wherein the encrypted data can be further remotely deleted or disabled by the original owner if the storage media of the encrypted files such as these from mobile phone or digital cameras is physically lost. Additionally, the originally encrypted data can be remotely re-enabled and recovered once the storage media or the encrypted file is found. This method provides additional layer of protection to the original data even when the network connected device is lost by the original owner or the content on it is obtained through illegal means by unauthorized personnel.

15. A method, apparatus and method of encryption and decryption, according to claim 9, wherein all user data or any portion of the user data can be encrypted and decrypted in real time when it is generated, received, or stored. Even when the device, where the data is stored, is compromised due to a security breach, the data itself is still protected. A method, apparatus and system of encryption and decryption, according to claim 9, wherein one user, who is using a network device to talk to another user, can choose to encrypt his or her real time voice conversation any time based on the present invention in order to prevent others from tapping and listening to the live conversation in the middle. A method, apparatus and system of encryption and decryption, according to claim 9, wherein one user, who is using a network device to text or chat to another user, can choose to encrypt his or her text or chat messages in real time any time based on the present invention in order to prevent others from obtaining the message contents, intentionally or accidentally.

16. A method, apparatus and system of encryption and decryption, according to claim 9, wherein the minimum amount of computation and memory are required to complete the encryption and decryption, which is based on logical operation with the binary data with small key sizes. When data is written into a storage device, it passes through the security engine of the present invention, which will only encrypt the data but not touch the protocol carrying the transmitting data.
